(19) United States
(12) Patent Application Publication
(10) Pub. No.: US 2011/0250431 A1
(43) Pub. Date: Oct. 13, 2011

(54) Gas structural product

(76) Inventor: Ernesto Di Chio, Bari (IT)

(21) Appl. No.: 12/448,765

(22) PCT Filed: Jan. 3, 2008
(86) PCT No.: PCT/IT2008/000009

§ 371 Date: Jun. 24, 2011

(30) Foreign Application Priority Data
Jan. 4, 2007 (IT) BA2007A000001

(51) Int. Cl. B32B 3/26

(52) U.S. Cl. 428/305.5; 428/304.4

(57) ABSTRACT

A structural product comprising: one or more layers of a component lightened by the presence of cavities and made of steel manufactured article with multiple-cells configuration, that can be obtained from the integration of hermetically sealed tube-like units; a layer of other materials that embeds the lightened component so as to obtain a modular unit with a rectangular section; and an outer coating layer. Inside the cavities is present a compressed gas mainly helium, and/or vacuum.

### TECHNICAL FIELD

The present invention relates to a gas structural product, suitable i.e. to realize structural elements and whole structures.

### BACKGROUND ART

Realizing structures for the building and the constructions using per-fabricated modular elements manufactured out of metal, composite materials (among which the reinforced concrete) or polymers, is known. The main critical factor of the mentioned conventional technique is represented by the construction weight of the structure.

Improved structural sandwich plate elements are described in the patent application WO 02/078948 A. They are characterized by the presence in the core of hollow units that, essentially, serve to define a material free space in the core, providing so an effective weight reduction.

### DISCLOSURE OF INVENTION

An object of the present invention is to utilize a compressible fluid made of inert gas, mainly helium, or of air compressed inside cavities, in order to confer rigidity, and consequent structural function, to the steel and/or composite material structural product, of which the cavities form integrating part.

Another object of the present invention is to reduce the construction weight of the structural product, characteristic that turns out particularly important in the realization of manufactured articles on work of art.

On the basis of the invention, the innovative structural product reaches all the stated objects and, in particular, performs its function (which is to resist to structural loads and stresses or to form integrating part of a structure) more effectively in comparison to what acquired by the state of the art, we being able to foresee also inside a conventional structural element a “component lightened” by the presence of cavities inside which, in a selective manner, a gas characterized by opportune and appropriate pressure values is injected and/or an opportune vacuum degree is produced. The presence of gas compressed inside the cavities enables us, in fact, to obtain higher rigidity, stability and structural strength, while the selective vacuum production inside the cavities makes it possible, for particular applications, an extension of the structural product functions.

The use of inert gas can, moreover, increase the conformity of the structural manufactured article with the security qualifications either at level of elements and materials or at level of building and of exercise.

The gas pressure value and/or vacuum degree can be various depending on the requirements desired for structural function or in general.

The materials, the dimensions, the shape of the cross-section and the general characteristics of the cavities (tube-like manufactured articles) and of the different elements composing the structural product that is the subject-matter of the present invention could be varied depending on the requirements for the use to which the structural element subject-matter of the present invention is designed.

The present invention will be described below with reference to possible configurations of model realizations and the accompanying schematic drawings, in which:

### BRIEF DESCRIPTION OF DRAWINGS

FIG. 1 is a cross-sectional view of a “lightened component” of the structural product according to a first embodiment of the invention.

FIG. 2 is a cross-sectional view of the structural product subject of the invention comprising the “lightened component” of FIG. 1 in two superposed layers.

FIG. 3 is a cross-sectional view of a “lightened component” of the structural product according to a second embodiment of the invention.

FIG. 4 is a cross-sectional view of the structural product subject of the invention comprising the “lightened component” of FIG. 3 in two superposed layers.

### BEST MODE FOR CARRYING OUT THE INVENTION

### Embodiment 1

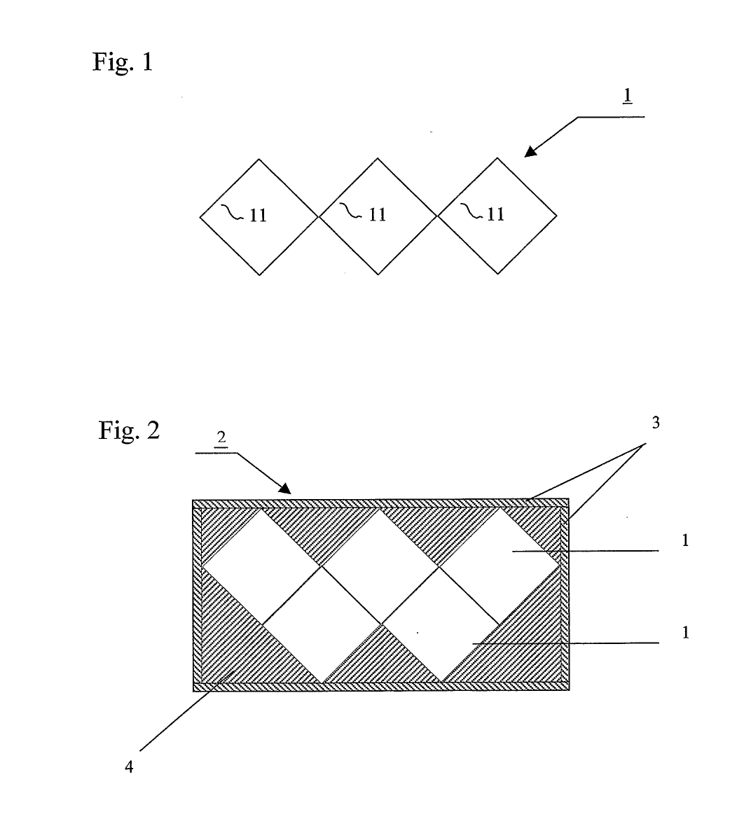

FIG. 1 shows in cross-section a “lightened component” (1) according to a first embodiment of the present invention.

The component (1) exhibits a multiple-cells configuration.

As shown in FIG. 1 the “lightened component” (1) comprises more tube-like units (11), developing in the longitudinal direction, integrated to form a single structure. The tube-like units (11) are square in section and oriented as illustrated.

The cross section, the dimensions, the positioning of the tube-like units and the number of layers may be varied to provide the desired shape of the cells inside the completed structural product for convenience in manufacturing or to provide the necessary physical properties of the lightened component.

A model structural product (2) is shown in FIG. 2.

It can be noted that the lightened component (1) in two superposed layers is englobed in other material (4) obtaining a modular unit with a rectangular section that in figure results bounded by a further outer layer (3).
The outer layer may be present on one or more side-faces.

As represented in FIGS. 1 and 2, the lightened component presents some cavities inside which in a selective manner compressed gas is injected or an opportune vacuum degree is producted. The gas function is the structural one i.e. to provide higher rigidity, stability and structural strength to the component in which it is embedded.

As a consequence the primary function of the lightened component is to define some cavities to optimize the gas or vacuum distribution in order to provide a lightweight structural product with the desired structural performance requirements.

The vacuum production makes it possible to extend the functions of the structural product.

The section shape, the dimensions and the number of the tube-like units (11) will be therefore selected and fixed according to the cavities dimensions and the specific application for which the structural product is designed.

### Embodiment 2

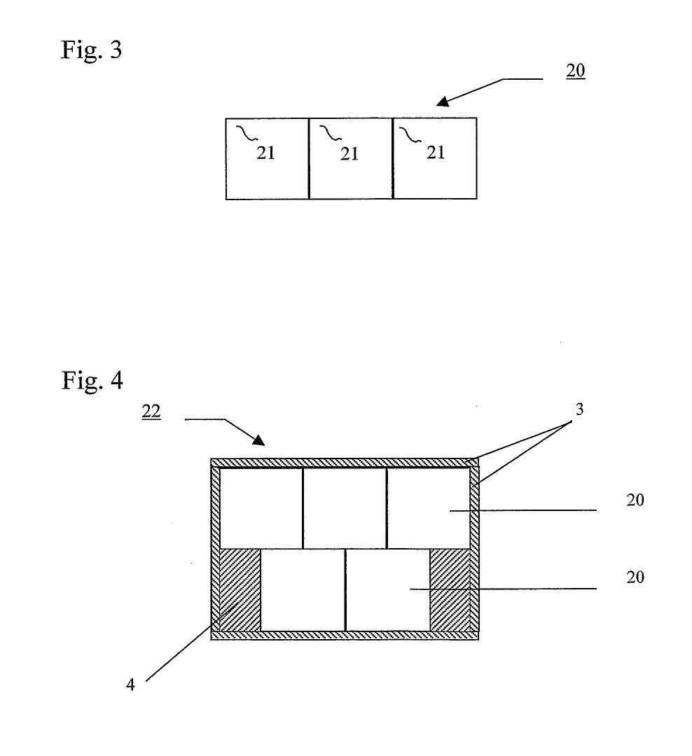

A second mode for carrying out the present invention is shown in FIGS. 3 and 4. According to the second embodiment the “lightened component” (20) can perform the same functions of the lightened component (1) of the first embodiment, but it presents different characteristics.

The tube-like units (21) are square in section and oriented as illustrated in FIG. 3, giving an uniform thickness to the component.
The cavities inside the model structural product (22) are defined using two superposed layers of the lightened component (20) as shown in FIG. 4.

### Embodiment 3

It can be appreciated that more layers, also different, of lightened components may be used in a simple structural product.

Such components could be arranged each other perpendicularly or at any other orientation.

These are the schematic modalities sufficient to the expert person to realize the invention, therefore in concrete application, there will be some variants without prejudice to the substance of the innovative concept.

Therefore, with reference to the preceding description, are expressed the following claims:

1) A structural product comprising:
A component lightened by the presence of cavities and made of steel manufactured article with multiple-cells configuration, that can be obtained from the integration of hermetically sealed tube-like units;
A layer of other materials that embeds the lightened component so as to obtain a modular unit with a rectangular section;
and an outer coating layer.
characterized by the presence, inside the cavities of the lightened component, of inert gas or air, injected in a selective manner with opportune and appropriate pressure value, or of an opportune vacuum degree, produced in a selective manner.

2) A structural product according to claim 1, characterized by the fact that the inert gas is the helium.

3) A structural product according to claim 1 or 2 characterized by the fact that the lightened component is carried out also considering a composite material;

4) A structural product according to any one or more of the preceding claims, comprising at least two layers of the lightened component.

5) A structural product, according to all the preceding claims, characterized by the fact that its production, its commercialization, have to be understood protected by the present patent of invention as it is described and illustrated.
